(19) United States
(12) Patent Application Publication
(10) Pub. No.: US 2002/0005816 A1
(43) Pub. Date: Jan. 17, 2002

(54) Satellite dish antenna alignment device

(76) Inventors: Carroll Ginther, Garden City, KS (US); Verlyn Ginther, Garden City, KS (US)

Correspondence Address: KIMBERLY A. WINGATE, KLENDA, MITCHELL, AUSTERMAN & ZUERCHER, L.L.C., 1600 EPIC CENTER, 301 NORTH MAIN, WICHITA, KS, 67202-4888, US

(21) Appl. No.: 09/882,483

(22) Filed: Jun. 14, 2001

Related U.S. Application Data
(60) Provisional application No. 60/218,691, filed on Jul. 17, 2000.

(51) Int. Cl. H01Q 1/08; H01Q 3/02; H01Q 1/12

(52) U.S. Cl. 343/880; 343/892; 343/882

(57) ABSTRACT

A satellite dish antenna alignment device is described for use with a commercially available satellite dish. Said device enables an installer of such a satellite dish to mount the mast assembly in such a way that the satellite dish antenna is properly aligned with respect to a particular satellite. The alignment device is removably placed over the mast assembly arm of the satellite dish antenna and includes a bubble level, a map and a compass for indicating the placement of the directional position of the mast assembly arm for permanent affixation to the mounting surface.

### CROSS REFERENCE TO RELATED APPLICATION

Benefit of the filing date of co pending provisional application number 60/218691 filed on Jul. 17, 2000 is claimed.

### BACKGROUND OF THE INVENTION

This invention relates to a satellite dish antenna alignment device and more particularly to an alignment device which enables the mast assembly, when mounted, to allow the satellite dish antenna to be aligned with respect to a particular satellite so as to receive the signals from the satellite.

Many different companies provide satellite television services and each company uses a particular satellite to transmit signals to their customers. In order for satellite antennas to receive the signals from the satellite, it is necessary that the satellite dish antenna be properly aligned with respect to the associated satellite. Generally, the satellite receivers have an antenna and dish portion mounted on the end of a mast assembly arm so that the dish, once mounted, will collect and focus the satellite signal into the antenna. The alignment of the satellite dish antennas frequently requires that at least two people be involved and the same is costly and time-consuming. Frequently, the manufacturer of the receiving equipment will provide alignment information to the installers with that information being related to particular zip codes. Additionally, electronic devices have been provided for use in aligning satellite dish antennas, which measure the strength of the satellite signals. However, it is necessary for the satellite dish antenna to be generally aligned with the satellite before those electronic devices will function properly. U.S. Pat. Nos. 5,977,922 and 5,576,722 specifically provide for an alignment device for a satellite antenna for use by one person, which is secured to the amplifier support arm and makes use of a compass for indicating the directional alignment of the support arm and a clinometer used to indicating the angle of inclination of the support arm with respect to horizontal.

However, the present invention allows for alignment of the satellite dish antenna on the mast assembly arm by one person without the need for first affixing the satellite dish antenna to the mast assembly arm, by use of a bubble level and a compass in combination with a specifically marked map applied to the tubular member creating the satellite dish antenna alignment device. The instant invention provides such ease of alignment, completion of the outside installation and alignment of the satellite dish antenna provides that such signal strength received is at least 80% before the use of the electronic aiming device to maximize the signal reception by the satellite receiving equipment.

### SUMMARY OF THE INVENTION

In the instant invention, the satellite dish antenna alignment device allows a simple and easy installation of a satellite dish antenna by providing for proper placement of the satellite dish antenna arm on the mast assembly arm by applying the alignment device to the mast assembly arm, using the bubble level permanently affixed thereto, to level the mast assembly arm. Next, by use of the compass, while the alignment device remains on the top end of the mast assembly arm, the device is turned to face north, allowing the installer to find the appropriate city on the map and mark the correct placement of the satellite on the mast assembly arm and mark the bracket for application to the mast assembly arm, permanently affixing the satellite dish in proper alignment.

### BRIEF DESCRIPTION OF THE DRAWINGS

FIG. 1 is a perspective view of the satellite dish antenna assembly.

FIG. 2 is a side view of the satellite dish antenna assembly with the satellite dish antenna alignment device applied to the mast assembly arm.

FIG. 3 is a side view of the mounting bracket for the dish antenna.

FIG. 4 is a top view of the satellite dish antenna alignment device showing placement of the compass.

FIG. 5 is a front view of the satellite dish antenna alignment device showing placement of the bubble level.

FIG. 6 is a side view of the satellite dish antenna alignment device.

### DESCRIPTION OF THE PREFERRED EMBODIMENT

With reference to FIG. 1 is shown a conventional satellite dish antenna widely available on the market. All satellite dish antennas normally include a mast assembly arm 8 having some sort of adjustable arm mounting bracket 10, see FIG. 3, at the lower end thereof for mounting the mast assembly arm 8 on a suitable supporting surface such as a roof, wall, floor, etc.

The satellite dish antenna 12 must be properly aligned or positioned with respect to a particular satellite so that the satellite dish antenna will properly collect the satellite signal. In most instances, the manufacturer of the satellite receiving equipment will provide information to the installer of the satellite dish antenna concerning the proper alignment (azimuth and elevation) of the unit based upon zip codes. For example, if the dish antenna is to be installed in zip code 67846, and is being used with the DIRECTV™ the manufacturer will indicate that the satellite dish antenna 12 must be aimed along a certain compass heading or azimuth and that the satellite dish antenna 12 must be elevated to a certain acute angle of degrees with respect to the horizontal. It is for such alignment purposes that the satellite alignment device 14 of this invention has been developed.

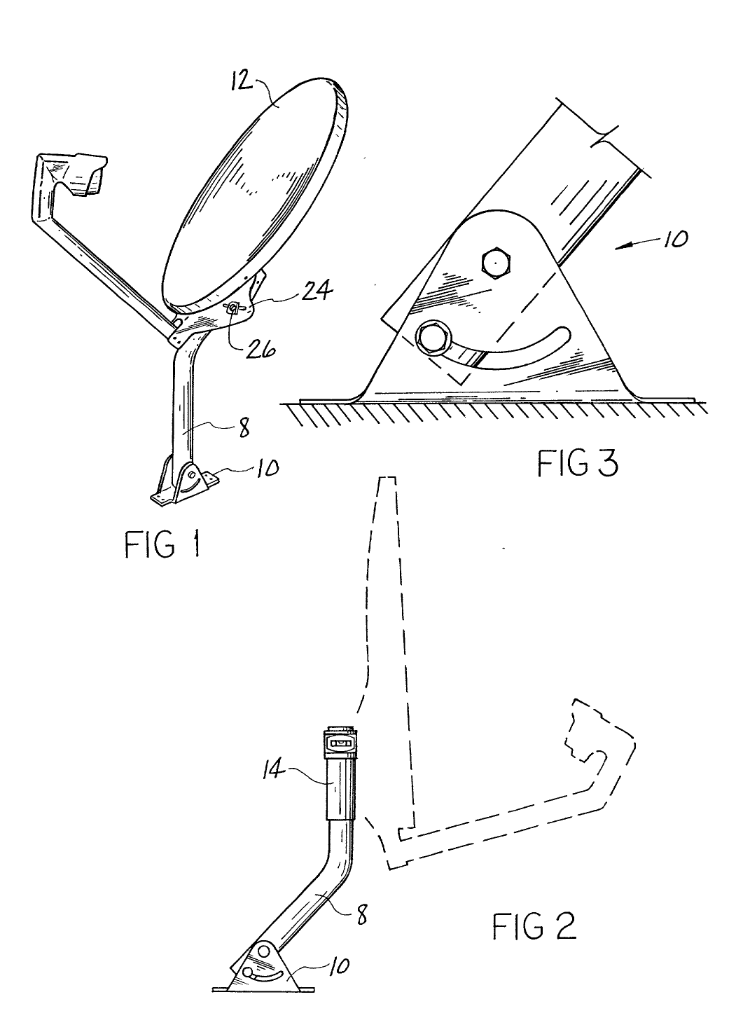

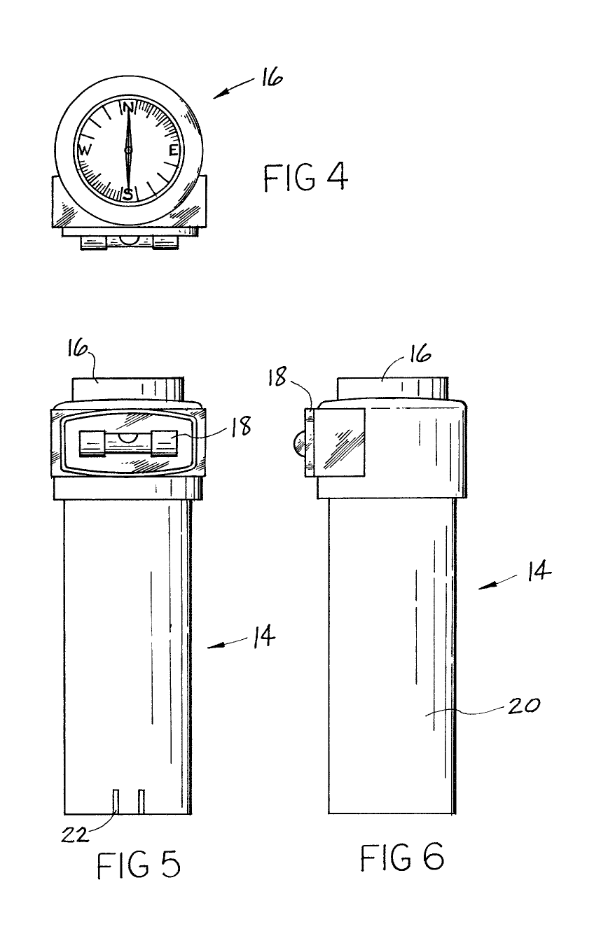

With reference to FIG. 2 and FIG. 3, the mast assembly arm 8 is then placed within the mounting bracket, which mounting bracket 8 is permanently mounted on its intended supporting surface. With reference to FIG. 2, the satellite alignment device 14 is then placed over the top of the mast assembly arm 8. The mast assembly arm 8 is first aligned by use of the bubble level 18, moving the mast assembly arm in a horizontal fashion until the bubble level 18 shows level placement of the mast assembly arm 8. Then, with reference to FIG. 4 and FIG. 5, using the compass 16 permanently affixed to the top end of the tubular member of the satellite alignment device 14, the satellite alignment device 14 is turned in a clockwise or counterclockwise direction until the needle of the compass 16 is facing north. Using the map 20 permanently affixed to the exterior of the tubular member of the satellite alignment device 14 and the notch made thereto 22, the applicable city is found and a mark is made on the mast assembly arm 8 and on the back of the dish antenna bracket 24 for the azimuth placement of the satellite dish antenna 12 on the mast assembly arm 8. With reference to FIG. 1, the marks made on the dish antenna bracket 24 and the mast assembly arm 8 are aligned. When said marks are aligned, the satellite dish antenna bracket 24 is tightened onto the mast assembly arm 8 via the use of the dish antenna bracket bolt 26 applied to the bracket in conventional fashion to maintain the satellite dish antenna 12 in its proper position. The alignment of the satellite dish antenna 12 may then be electronically “fine-tuned” if needed or desired.

1. What is claimed is a satellite dish antenna alignment device used to accurately mount a satellite dish antenna, said satellite dish antenna including a mast assembly, a mast assembly arm, a mounting bracket, a satellite dish antenna and a satellite dish, said satellite dish antenna and satellite dish operatively secured to said mast assembly arm with said mounting bracket for movement therewith with respect to said mast assembly, the satellite dish antenna alignment device comprising:
A tubular member having a top end and a bottom end, where the tubular member possess a circumference sufficient to allow placement of the bottom end of the satellite dish antenna alignment device over the top of the mast assembly arm,
A bubble level permanently mounted on the exterior of the tubular member of the satellite alignment device, allowing for the aiming and leveling of the mounting bracket both from front to back and from side to side,
a compass permanently mounted on the top end of the tubular member for indicating the direction in which said mast assembly arm is pointing, and
a map permanently affixed around the outside diameter of the tubular member for indicating the angle at which the mounting bracket will be placed on the mast assembly arm for alignment of the satellite dish antenna.
